(19) United States
(12) Patent Application Publication
(10) Pub. No.: US 2020/0211163 A1
(43) Pub. Date: Jul. 2, 2020

(54) IMAGE COMPENSATION METHOD AND IMAGE PROCESSING CIRCUIT

(71) Applicant: Novatek Microelectronics Corp., Hsinchu (TW)

(72) Inventor: Yu-Yi Chien, New Taipei City (TW)

(73) Assignee: Novatek Microelectronics Corp., Hsinchu (TW)

(21) Appl. No.: 16/234,566

(22) Filed: Dec. 28, 2018

(51) Int. Cl. G06T 5/00; G09G 5/02

(52) U.S. Cl. CPC G06T 5/003; G09G 5/02; G09G 2320/029; G09G 2360/16; G09G 2320/0242; G06T 2207/10024

(57) ABSTRACT

The invention provides an image compensation method suitable to a display. First, an image processing circuit obtains pixel data related to a current pixel, a first and a second adjacent pixels from an image frame. The first and the second adjacent pixels are respectively located at two opposite sides of the current pixel. Then, the image processing circuit determines whether a color block edge exists between the current pixel, the first adjacent pixel and the second adjacent pixel according to the pixel data related to the current pixel, the first adjacent pixel and the second adjacent pixel. The image processing circuit performs first color edge compensation on the pixel data related to the current pixel when determining that the color block edge exists between the current pixel and the first adjacent pixel and no color block edge exists between the current pixel and the second adjacent pixel. An image processing circuit is further provided.

### BACKGROUND

### Field of the Invention

The invention relates to an image process technique and more particularly, to an image compensation method and an image processing circuit.

### Description of Related Art

In a display panel controlling an emission ratio of subpixels for color mixing to present an image, the subpixels of each pixel has a certain degree of non-uniformity in arrangement. For instance, the certain degree of non-uniformity may appear in either the arrangement of the subpixels in true color or the arrangement of the subpixels for subpixel rendering (SPR). Based on the non-uniformity characteristic of subpixels, a color fringe phenomenon may occur to edges of an object in an image frame. The color fringe phenomenon is resulted from a reason that no subpixels in three primary colors are provided at each edge of one pixel, and thus, the edges of a color block (object) after being visually integrated by human eyes may exhibit in an unexpected color. In other words, a user may view a color fringe exhibiting in an unexpected color at the color block edge displayed at the image frame.

For descriptive convenience, for any one of the pixels of the display panel which serves as an illustrative example, it is assumed that red and blue subpixels are present at an upper edge of a pixel, blue subpixels are present at a right edge of this pixel, green and blue subpixels are present at a lower edge of this pixel, and red and green subpixels are present at a left edge of this pixel. Taking a white block (object) in a black background as an example, the user may view a magenta edge present at an upper edge of the white block, a blue edge present at a right edge of the white block, a cyan edge present at a lower edge of the white block and a yellow edge present at a left edge of the white block.

### SUMMARY

The invention provides an image compensation method and an image processing circuit to improve/prevent a color fringe phenomenon at a color block edge.

According to an embodiment of the invention, an image compensation method is provided. First, pixel data related to a current pixel, a first adjacent pixel and a second adjacent pixel are obtained from an image frame by an image processing circuit, wherein the first and the second adjacent pixels are respectively located at two opposite sides of the current pixel. Then, whether a color block edge exists between the current pixel, the first adjacent pixel and the second adjacent pixel are determined by the image processing circuit according to the pixel data related to the current pixel, the first adjacent pixel and the second adjacent pixel. First color edge compensation is performed on the pixel data related to the current pixel by the image processing circuit when determining that the color block edge exists between the current pixel and the first adjacent pixel and no color block edge exists between the current pixel and the second adjacent pixel.

An image processing circuit for a color fringe phenomenon is provided. The image processing circuit includes a capture circuit, an edge determination circuit and a compensation circuit. The capture circuit is configured to obtain pixel data related to a current pixel, a first adjacent pixel and a second adjacent pixel from an image frame, wherein the first and the second adjacent pixels are respectively located at two opposite sides of the current pixel. The edge determination circuit is coupled to the capture circuit, and configured to determine whether a color block edge exists between the current pixel, the first adjacent pixel and the second adjacent pixel according to the pixel data related to the current pixel, the first adjacent pixel and the second adjacent pixel. The compensation circuit is coupled to the edge determination circuit. The compensation circuit performs first color fringe compensation on the pixel data related to the current pixel when determining that the color block edge exists between the current pixel and the first adjacent pixel and no color block edge exists between the current pixel and the second adjacent pixel.

The image compensation method and the image processing circuit provided by the embodiments of the invention can check/determine whether the color block edge exists between the current pixel and the first adjacent pixel and check/determine whether the color block edge exists between the current pixel and the second adjacent pixel, so as to obtain check/determination results. According to the check/determination results, the image processing circuit can dynamically determine whether to perform the first color edge compensation on the pixel data related to the current pixel. Thus, the image compensation method and the image processing circuit can effectively mitigate/prevent the color fringe phenomenon from appearing at the color block edges, which allows a viewer to experience better visual comfort.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram of an image processing circuit according to an embodiment of the invention.

FIG. 2 is a flowchart of an image compensation method according to an embodiment of the invention.

FIG. 3 is a schematic diagram of a layout of a pixel array of the display panel according to an embodiment of the invention.

FIG. 4 is a schematic diagram of a layout of four pixels adjacent to one another according to an embodiment of the invention.

FIG. 5 is a flowchart of steps of an image compensation method according to another embodiment of the invention.

### DESCRIPTION OF EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

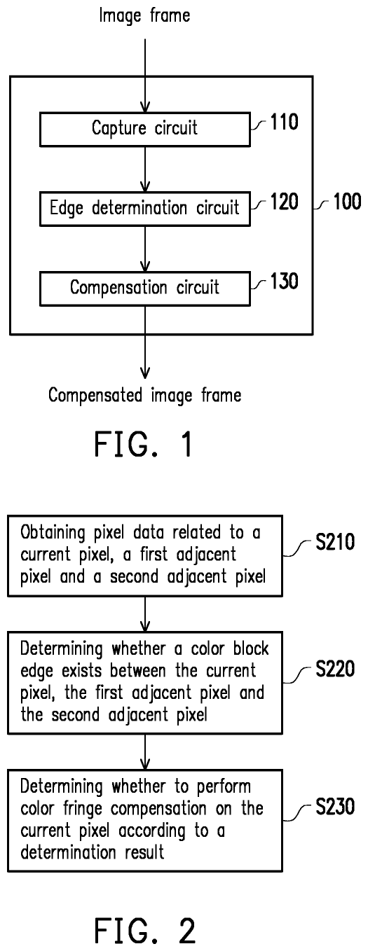

Referring to FIG. 1, FIG. 1 is a schematic circuit block diagram of an image processing circuit 100 according to an embodiment of the invention. According to an application requirement, the image processing circuit 100 illustrated in FIG. 1 may be applied to a display of any type. For instance, the display may be one including, for example, a liquid crystal display panel (LCD panel), an organic electro-luminescent display (OELD) panel, a plasma display panel (PDP), an electronic paper panel, an electro wetting display panel or a display panel of other types.

FIG. 2 is a flowchart of an image compensation method according to an embodiment of the invention. Referring to FIG. 1 and FIG. 2, the image processing circuit 100 includes a capture circuit 110, an edge determination circuit 120 and a compensation circuit 130. In step S210, the capture circuit 110 may receive an image frame and obtain pixel data related to a current pixel, a first adjacent pixel and a second adjacent pixel. The first and the second adjacent pixels are respectively located at two opposite sides of the current pixel.

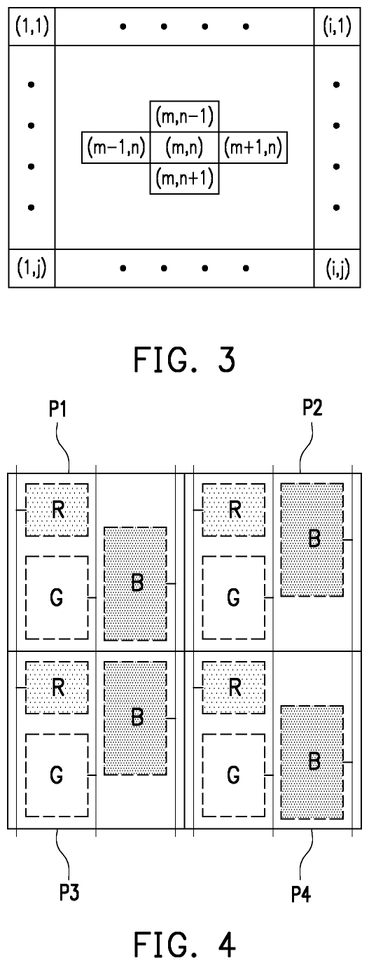

For instance, FIG. 3 is a schematic diagram of a layout of a pixel array of the display panel according to an embodiment of the invention. In the display panel illustrated in FIG. 3, a pixel array is composed of pixels arranged on i columns and on j rows (which is referred to as an i*j pixel array hereinafter), wherein i and j may be arbitrary integers determined based on a design requirement. The current pixel is located at a position on an mth column and on an nth row in the pixel array, which may be denoted as (m,n), wherein m is an integer greater than or equal to 1 and less than or equal to i, and n is an integer greater than or equal to 1 and less than or equal to j. For the current pixel located at the position of (m,n), when one of the adjacent pixels which are located at a position of (m,n−1) and a position of (m,n+1) is referred to as the first adjacent pixel, the other one is referred to as the second adjacent pixel. Alternatively, when one of the adjacent pixels which are located at a position of (m−1,n) and a position of (m+1,n) is referred to as the first adjacent pixel, the other one is referred to as the second adjacent pixel.

Referring to FIG. 1 and FIG. 2, based on a design requirement, the “pixel data” as referred to in step S210 may be data with any physical meaning related to the pixels. For instance, in some embodiments, the pixel data may be grayscale values. In some other embodiments, the pixel data may be brightness values. In yet other embodiments, the pixel data may be chroma values.

The edge determination circuit 120 is coupled to the capture circuit 110. In step S220, the edge determination circuit 120 may determine whether any color block edge exists between the current pixel, the first adjacent pixel and the second adjacent pixel according to the pixel data (e.g., grayscale values or brightness values) related to the current pixel, the first adjacent pixel and the second adjacent pixel. The color block edge may be an edge of any color block in the image. For example (but not limited to), the block may be an object in the image.

For instance, the edge determination circuit 120, in step S220, may calculate the brightness values of the current pixel, the first adjacent pixel and the second adjacent pixel by using the grayscale values (i.e., the pixel data) of the current pixel, the first adjacent pixel and the second adjacent pixel. The edge determination circuit 120, in step S220, may compare the brightness value of the current pixel with the brightness value of the first adjacent pixel to obtain a first comparison result. The edge determination circuit 120 may determine whether the color block edge exists between the current pixel and the first adjacent pixel according to the first comparison result. The edge determination circuit 120 may compare the brightness value of the current pixel with the brightness value of the second adjacent pixel to obtain a second comparison result. The edge determination circuit 120 may determine whether the color block edge exists between the current pixel and the second adjacent pixel according to the second comparison result.

For example (but not limited to), the first comparison result may include a difference value (a first bright difference value) between the brightness value of the current pixel and the brightness value of the first adjacent pixel, and the second comparison result may include a difference value (a second bright difference value) between the brightness value of the current pixel and the brightness value of the second adjacent pixel. When the first bright difference value is greater than a certain threshold value, the edge determination circuit 120 may determine that “the color block edge exists between the current pixel and the first adjacent pixel”. The threshold value may be determined based on a design requirement. On the contrary, when the first bright difference value is less than or equal to the threshold value, the edge determination circuit 120 may determine that “no color block edge exists between the current pixel and the first adjacent pixel”. By deducing by analogy, when the second bright difference value is greater than the threshold value, the edge determination circuit 120 may determine that “the color block edge exists between the current pixel and the second adjacent pixel”. When the second bright difference value is less than or equal to the threshold value, the edge determination circuit 120 may determine that “no color block edge exists between the current pixel and the second adjacent pixel”.

Continuously referring to FIG. 1 and FIG. 2, the compensation circuit 130 is coupled to the edge determination circuit 120. In step S230, the compensation circuit 130 may determine whether to perform color fringe compensation on the pixel data related to the current pixel according to a determination result of the edge determination circuit 120. For instance, when the edge determination circuit 120 determines that “a color block edge exists between the current pixel and one of the adjacent pixels (e.g., the first adjacent pixel)” and “no color block edge exists between the current pixel and the other adjacent pixel (e.g., the second adjacent pixel), the compensation circuit 130 may perform first color fringe compensation on the pixel data related to the current pixel. By contrast, when the edge determination circuit 120 determines that “no color block edge exists between the current pixel and the first adjacent pixel” and “no color block edge exists between the current pixel and the second adjacent pixel”, the compensation circuit 130 may not perform the first color fringe compensation on the pixel data related to the current pixel. Based on a design requirement, in the present embodiment, when the edge determination circuit 120 determines that “the color block edge exists between the current pixel and the first adjacent pixel” and “the color block edge exists between the current pixel and the second adjacent pixel”, the compensation circuit 130 does not perform the first color fringe compensation on the pixel data related to the current pixel.

The present embodiment does not limit the compensation manner of the first color fringe compensation in step S230. For instance, the compensation circuit 130 may calculate a weighted average of a brightness value of a subpixel (a target subpixel) of the current pixel and a brightness value of a corresponding subpixel in the first adjacent pixel, so as to obtain a new brightness value of the target subpixel in the current pixel. The corresponding subpixel in the first adjacent pixel and the target subpixel in the current pixel have the same color. In some embodiments, the compensation circuit 130 may adjust only the brightness value of the target subpixel in the current pixel which is adjacent to the first adjacent pixel, but not adjust the brightness value of other subpixels in the current pixel which are far away from the first adjacent pixel. In some other embodiments, the compensation circuit 130 may adjust the brightness values of all the subpixels in the current pixel.

For instance, the compensation circuit 130, in step S230, may perform the brightness adjustment (i.e., the color fringe compensation) on the target subpixel in the current pixel by using Formula 1. In Formula 1, Y1′ represents the new brightness value obtained after the target subpixel in the current pixel is adjusted, Y1 represents the original brightness value of the target subpixel in the current pixel, and Y2 represents the brightness value of the corresponding subpixel in the first adjacent pixel. S1 and S2 represent adjustment parameters which are respectively different (or the same). The adjustment parameters S1 and S2 may be any real numbers determined based on a design requirement. For instance, in an embodiment, the adjustment parameter S2 may be a positive real number less than 1, and S1=1−S2.

Y1′=Y1*S1+Y2*S2 Formula 1

FIG. 4 is a schematic diagram of a layout of four pixels adjacent to one another according to an embodiment of the invention. FIG. 4 illustrates four pixels P1, P2, P3 and P4, wherein each of the pixels P1-P4 has a red subpixel R, a green subpixel G and a blue subpixel B. It is assumed herein that the pixels P1 and P2 are located on an odd-numbered row (e.g., a 1st row), the pixels P3 and P4 are located on an even-numbered row (e.g., a 2nd row), the pixels P1 and P3 are located on an odd-numbered column (e.g., a 1st column), and the pixels P2 and P4 are located on an even-numbered column (e.g., a 2nd column).

Table 1 is a color fringe compensation table showing the “edge determination” and the “color fringe compensation” which are performed along a vertical direction as depicted in FIG. 3 according to an embodiment of the invention. It is assumed herein that an address of the current pixel is (m,n), and two adjacent pixels of the current pixel are located at addresses of (m,n+1) and (m,n−1), respectively. Namely, in the present embodiment, the “edge determination” (step S220) and the “color fringe compensation” (step S230) may be performed along the vertical direction as depicted in FIG. 3. It should be noted that even though the “edge determination” and the “color fringe compensation” are performed along the vertical direction in the present embodiment, the image processing circuit 100 may perform the “edge determination” and the “color fringe compensation” along a lateral direction as depicted in FIG. 3 in other embodiments. In the embodiments where the “edge determination” and the “color fringe compensation” are performed along the lateral direction, when the address of the current pixel is (m,n), the two adjacent pixels of the current pixel are located at addresses of (m−1,n) and (m+1,n), respectively. The embodiments where “the edge determination and the color fringe compensation are performed along the lateral direction” may refer to the description related to the embodiments where “the edge determination and the color fringe compensation are performed along the vertical direction” and thus, will not be repeated. In other embodiments, the image processing circuit 100 may first perform the first “edge determination” and the first “color fringe compensation” along the vertical direction as depicted in FIG. 3 and then, perform the second “edge determination” and the second “color fringe compensation” along the lateral direction as depicted in FIG. 3. Alternatively, the image processing circuit 100 may initially perform the first “edge determination” and the first “color fringe compensation” along the lateral direction as depicted in FIG. 3 and then, perform the second “edge determination” and the second “color fringe compensation” along the vertical direction as depicted in FIG. 3.

TABLE 1
Color fringe compensation table

| | m + n are an odd number | m + n are an even number |
|---|---|---|
| A color block | When the brightness of | When the brightness of |
| edge exists | (m, n) is greater than the | (m, n) is greater than the |
| between (m, n) | brightness of (m, n − 1), | brightness of (m, n − 1), |
| and (m, n − 1) | the brightness of the | the brightness of the |
| | subpixels R and B are | subpixel R is adjusted. |
| | adjusted. | When the brightness of |
| | When the brightness of | (m, n) is less than the |
| | (m, n) is less than the | brightness of (m, n − 1), |
| | brightness of (m, n − 1), | the brightness of the |
| | the brightness of the | subpixels R and B are |
| | subpixel R is adjusted. | adjusted. |
| A color block | When the brightness of | When the brightness of |
| edge exists | (m, n) is greater than the | (m, n) is greater than the |
| between (m, n) | brightness of (m, n + 1), | brightness of (m, n + 1), |
| and (m, n + 1) | the brightness of the | the brightness of the |
| | subpixel G is adjusted. | subpixels G and B are |
| | When the brightness of | adjusted. |
| | (m, n) is less than the | When the brightness of |
| | brightness of (m, n + 1), | (m, n) is less than the |
| | the brightness of the | brightness of (m, n + 1), |
| | subpixels G and B are | the brightness of the |
| | adjusted. | subpixel G is adjusted. |

Referring to FIG. 4 and Table 1, it is assumed herein that the current pixel is the pixel P1, and a color block edge exists between the pixel P1 and the pixel P3 (i.e., the first adjacent pixel), i.e., the color block edge exists between the address of (m,n) and the address of (m,n+1). The row number n (e.g., 1) and the column number m (e.g., 1) of the address of the pixel P1 are added as an even number. According to Table 1, in a condition that the brightness value of the pixel P1 (i.e., the current pixel) is less than the brightness value of the pixel P3 (i.e., the first adjacent pixel), the compensation circuit 130 may adjust the brightness value of the green subpixel G (i.e., the target subpixel) in the pixel P1 (without adjusting the brightness values of the subpixels R and B in the pixel P1). When the brightness value of the pixel P1 (i.e., the current pixel) is greater than with the brightness value of the pixel P3, the compensation circuit 130 may adjust the brightness value of the green subpixel G (i.e., the target subpixel) and the brightness value of the blue subpixel B (i.e., the target subpixel) in the pixel P1 (without adjusting the brightness value of the red subpixel R in the pixel P1). The adjustment of the brightness values may refer to the description related to Formula 1.

It is assumed that the current pixel is the pixel P4, and a color block edge exists between the pixel P4 and the pixel P2 (i.e., the first adjacent pixel), i.e., the color block edge exists between the address of (m,n) and the address of (m,n−1). The row number n (e.g., 2) and the column number m (e.g., 2) of the address of the pixel P4 are added as an even number. According to Table 1, in a condition that the brightness value of the pixel P4 (i.e., the current pixel) is greater than the brightness value of the pixel P2 (i.e., the first adjacent pixel), the compensation circuit 130 may adjust the brightness value of the red subpixel R (i.e., the target subpixel) in the pixel P4 (without adjusting the brightness values of the subpixels G and B in the pixel P4). When the brightness value of the pixel P4 is less than the brightness value of the pixel P2, the compensation circuit 130 may adjust the brightness values of the red subpixel R and the blue subpixel B in the pixel P4 (without adjusting the brightness value of the green subpixel G in the pixel P4). The adjustment of the brightness values may refer to the description related to Formula 1.

It is assumed that the current pixel is the pixel P3, and a color block edge exists between the pixel P3 and the pixel P1 (i.e., the first adjacent pixel), i.e., the color block edge exists between the address of (m,n) and the address of (m,n−1). The row number n (e.g., 2) and the column number m (e.g., 1) of the address of the pixel P3 are added as an odd number. According to Table 1, in a condition that the brightness value of the pixel P3 (i.e., the current pixel) is greater than the brightness value of the pixel P1 (i.e., the first adjacent pixel), the compensation circuit 130 may adjust the brightness values of the red subpixel R and the blue subpixel B in the pixel P3 (without adjusting the brightness value of the green subpixel G in the pixel P3). When the brightness value of the pixel P3 is less than the brightness value of the pixel P1, the compensation circuit 130 may adjust the brightness value of the red subpixel R in the pixel P3 (without adjusting the brightness values of the subpixels G and B in the pixel P3). The adjustment of the brightness values may refer to the description related to Formula 1.

It is assumed that the current pixel is the pixel P2, and a color block edge exists between the pixel P2 and the pixel P4 (i.e., the first adjacent pixel), i.e., the color block edge exists between the address of (m,n) and the address of (m,n−1). The row number n (e.g., 1) and the column number m (e.g., 2) of the address of the pixel P2 are added as an odd number. According to Table 1, in a condition that the brightness value of the pixel P2 (i.e., the current pixel) is greater than the brightness value of the pixel P4 (i.e., the first adjacent pixel), the compensation circuit 130 may adjust the brightness value of the green subpixel G in the pixel P2 (without adjusting the brightness values of the subpixels R and B in the pixel P2). When the brightness value of the pixel P2 is less than the brightness value of the pixel P4, the compensation circuit 130 may adjust the brightness values of the green subpixel G and the blue subpixel B in the pixel P2 (without adjusting the brightness value of the red subpixel R in the pixel P2). The adjustment of the brightness values may refer to the description related to Formula 1.

Referring to FIG. 1, when the current pixel is located at a frame edge of the image frame, the capture circuit 110 may obtain pixel data (e.g., grayscale values or brightness values) related to the current pixel and a third adjacent pixel from the image frame, wherein the frame edge and the third adjacent pixel are respectively located at two opposite sides of the current pixel. The edge determination circuit 120 may determine whether a color block edge exists between the current pixel and the third adjacent pixel according to the pixel data related to the current pixel and the third adjacent pixel. Being similar to the description related to step S220, the edge determination circuit 120 may calculate the brightness value of the current pixel and a brightness value of the third adjacent pixel according to the grayscale values of the current pixel and the third adjacent pixel. The edge determination circuit 120 may compare the brightness value of the current pixel with the bright value of the third adjacent pixel, so as to obtain a difference value (a third bright difference value) between the brightness value of the current pixel and the brightness value of the third adjacent pixel. When the third bright difference value is greater than a certain threshold value, the edge determination circuit 120 may determine that “the color block edge exists between the current pixel and the third adjacent pixel”. The threshold value may be determined based on a design requirement. On the contrary, when the third bright difference value is less than or equal to the threshold value, the edge determination circuit 120 may determine that “no color block edge exists between the current pixel and the third adjacent pixel”.

When it is determined that no color block edge exists between the current pixel and the third adjacent pixel and the brightness value of the current pixel is greater than a certain brightness threshold value, the compensation circuit 130 may perform second color fringe compensation on the pixel data related to the current pixel. The brightness threshold value may be determined based on a design requirement. The compensation circuit 130 may multiply a brightness value of a target subpixel in the current pixel by an adjustment parameter, so as to obtain a new brightness value of the target subpixel in the current pixel. For instance, the compensation circuit 130 may perform the brightness adjustment (i.e., the second color fringe compensation) on the target subpixel in the current pixel by using Formula 2. In Formula 2, Y1′ represents the new brightness value obtained after the target subpixel in the current pixel is adjusted, and Y1 represents the original brightness value of the target subpixel in the current pixel. S3 represents the adjustment parameter, wherein the adjustment parameter S3 may be any real numbers determined based on a design requirement. For instance, in an embodiment, the adjustment parameter S3 may be a positive real number less than 1.

Y1′=Y1*S3 Formula 2

When it is determined that the color block edge exists between the current pixel and the third adjacent pixel and the brightness value of the current pixel is less than the brightness threshold value, the compensation circuit 130 may perform third color fringe compensation on the pixel data related to the current pixel. The compensation circuit 130 may calculate a weighted average of the brightness value of the target subpixel in the current pixel and a brightness value of a corresponding subpixel of the third adjacent pixel, so as to obtain a new brightness value of the target subpixel in the current pixel. The corresponding subpixel in the third adjacent pixel and the target subpixel in the current pixel have the same color. For instance, the compensation circuit 130 may perform the brightness adjustment (i.e., the third color fringe compensation) on the target subpixel in the current pixel by using Formula 3. In Formula 3, Y1′ represents the new brightness value obtained after the target subpixel in the current pixel is adjusted, Y1 represents the original brightness value of the target subpixel in the current pixel, and Y3 represents the brightness value of the corresponding subpixel in the third adjacent pixel. S4 and S5 represent adjustment parameters which are respectively different (or the same), wherein the adjustment parameters S4 and S5 may be any real numbers determined based on a design requirement. For instance, in an embodiment, the adjustment parameter S5 may be a positive real number less than 1, and S4=1−S5.

Y1′=Y1*S4+Y3*S5 Formula 3

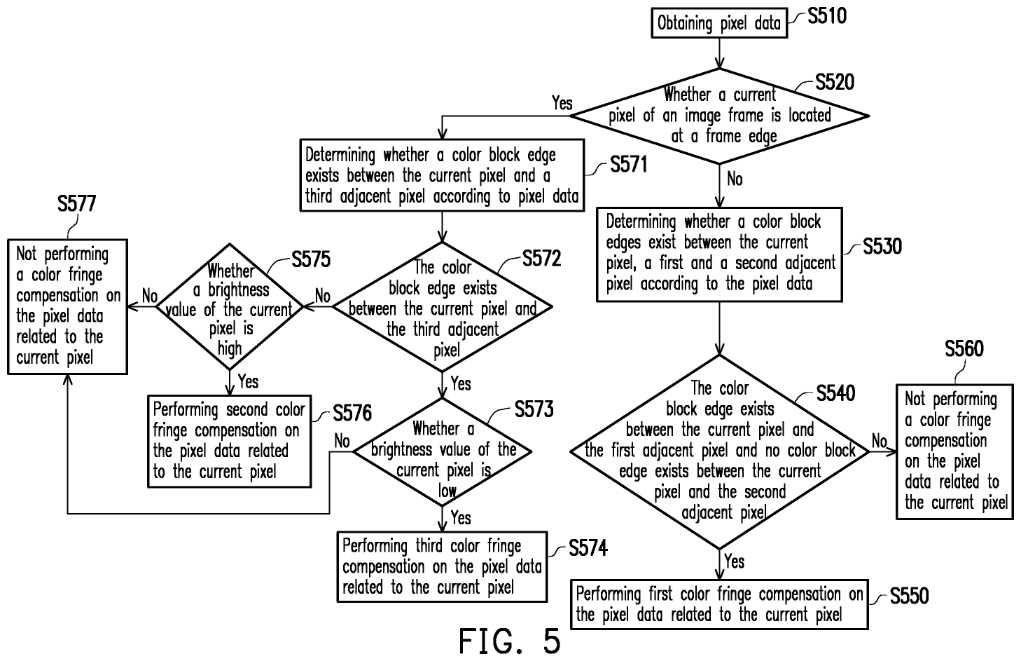

FIG. 5 is a flowchart of steps of an image compensation method according to another embodiment of the invention. Referring to FIG. 1 and FIG. 5, in step S510, the capture circuit 110 of the image processing circuit 100 may receive an image frame and obtain pixel data (e.g., grayscale values or brightness values) related to a current pixel and its adjacent pixels from the image frame. Step S510 may be inferred with reference to the description related to step S210 illustrated in FIG. 2. In step S520, the image processing circuit 100 may determine whether the current pixel of the image frame is located at a frame edge, namely, determine whether the current pixel is an edge pixel. If the current pixel is the edge pixel (i.e., the determination result of step S520 is “Yes”), step S571 may be performed. If the current pixel is not the edge pixel (i.e., the determination result of step S520 is “No”), step S530 may be performed.

In step S530, the edge determination circuit 120 of the image processing circuit 100 may determine whether a color block edge exists between the current pixel and a first adjacent pixel and whether a color block edge exists between the current pixel and a second adjacent pixel according to the pixel data related to the current pixel, the first adjacent pixel and the second adjacent pixel. Step S530 may be inferred with reference to the description related to step S220 illustrated in FIG. 2 and thus, will not be repeated.

When the edge determination circuit 120 determines that “the color block edge exists between the current pixel and one of the adjacent pixels (e.g., the first adjacent pixel)” and “no color block edge exists between the current pixel and the other adjacent pixel (e.g., the second adjacent pixel) (i.e., the determination result of step S540 is “Yes”), step S550 may be entered to perform the first color fringe compensation on the current pixel. The first color fringe compensation may be inferred with reference to the description related to step S220 illustrated in FIG. 2 and thus, will not be repeated. The descriptions related to the exemplary examples of FIG. 3, FIG. 4, Table 1 and Formula 1 may be applied to steps S540 and S550 illustrated in FIG. 5. When the determination result of step S540 is “No”, step S560 may be entered, i.e., the color fringe compensation is not performed on the pixel data related to the current pixel.

When the current pixel is the edge pixel (i.e., the determination result of step S520 is “Yes”), step S571 may be entered. In step S571, the edge determination circuit 120 of the image processing circuit 100 may determine whether a color block edge exists between the current pixel and a third adjacent pixel according to pixel data (e.g., grayscale values or brightness values) related to the current pixel and the third adjacent pixel obtained in step S510, wherein the frame edge and the third adjacent pixel are respectively located at two opposite sides of the current pixel. In step S571, the manner of determining whether the color block edge exists may be similar to that of step S530 and thus, will not be repeatedly described. Being similar to the description related to step S220 illustrated in FIG. 2, the edge determination circuit 120, in step S571 illustrated in FIG. 5, may calculate the brightness values of the current pixel and the third adjacent pixel according to the grayscale values of the current pixel and the third adjacent pixel. The edge determination circuit 120 may compare the brightness value of the current pixel with the bright value of the third adjacent pixel, so as to obtain a difference value (i.e., a third bright difference value) between the brightness value of the current pixel and the brightness value of the third adjacent pixel. When the third bright difference value is greater than a certain threshold value, the edge determination circuit 120 may determine that “the color block edge exists between the current pixel and the third adjacent pixel”. The threshold value may be determined based on a design requirement. On the contrary, when the third bright difference value is less than or equal to the threshold value, the edge determination circuit 120 may determine that “no color block edge exists between the current pixel and the third adjacent pixel”.

When the edge determination circuit 120 determines that “the color block edge exists between the current pixel and the third adjacent pixel” (i.e., the determination result of step S572 is “Yes”), steps S573 and S574 may be performed to determine whether to perform the third color fringe compensation on the current pixel. When the edge determination circuit 120 determines that “no color block edge exists between the current pixel and the third adjacent pixel” (i.e., the determination result of step S572 is “No”), steps S575 and S576 may be performed to determine whether to perform the second color fringe compensation on the current pixel.

In step S573, the brightness value of the current pixel may be checked. When the brightness value of the current pixel is low (the brightness value of the current pixel is less than a certain brightness threshold value), i.e., the determination result of step S573 is “Yes”, the compensation circuit 130 of the image processing circuit 100 may perform the third color fringe compensation on the pixel data related to the current pixel (step S574). The third color fringe compensation may be inferred with reference to the description related to Formula 3 and thus, will not be repeatedly described. When the determination result of step S573 is “No”, step S577 may be entered, i.e., the color fringe compensation is not performed on the pixel data related to the current pixel.

In step S575, the brightness value of the current pixel may be checked. When the brightness value of the current pixel is high (the brightness value of the current pixel is greater than a certain brightness threshold value), i.e., the determination result of step S575 is “Yes”, the compensation circuit 130 of the image processing circuit 100 may perform the second color fringe compensation on the pixel data related to the current pixel (step S576). The second color fringe compensation may be inferred with reference to the description related to Formula 2 and thus, will not be repeated. When the determination result of step S575 is “No”, the color fringe compensation is not performed on the pixel data related to the current pixel (step S577).

The image compensation method and the image processing circuit provided by the embodiments of the invention can check/determine whether any color block edge exists between the current pixel and the adjacent pixels, so as to obtain the check/determination results. According to the check/determination results, the image processing circuit can dynamically determine whether to perform the color edge compensation on the pixel data related to the current pixel. Thus, the image compensation method and the image processing circuit can effectively mitigate/prevent the color fringe phenomenon from appearing at the color block edges, which allows the viewer to experience visual comfort.

It should be finally mentioned that the embodiments above are provided merely for describing the technical solution of the invention, without inducing limitations to the invention. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image compensation method, comprising:
obtaining, by an image processing circuit, pixel data related to a current pixel, a first adjacent pixel and a second adjacent pixel from an image frame, wherein the first adjacent pixel and the second adjacent pixel are respectively located at two opposite sides of the current pixel;
determining, by the image processing circuit, whether a color block edge exists between the current pixel, the first adjacent pixel and the second adjacent pixel according to the pixel data related to the current pixel, the first adjacent pixel and the second adjacent pixel; and
performing, by the image processing circuit, first color fringe compensation on the pixel data related to the current pixel when determining that the color block edge exists between the current pixel and the first adjacent pixel and no color block edge exists between the current pixel and the second adjacent pixel.

2. The image compensation method according to claim 1, further comprising:
not performing the first color fringe compensation on the pixel data related to the current pixel when determining that no color block edge exists between the current pixel and the first adjacent pixel and no color block edge exists between the current pixel and the second adjacent pixel; and
not performing the first color fringe compensation on the pixel data related to the current pixel when determining that the color block edge exists between the current pixel and the first adjacent pixel and the color block edge exists between the current pixel and the second adjacent pixel.

3. The image compensation method according to claim 1, wherein the pixel data related to the current pixel, the first adjacent pixel and the second adjacent pixel are grayscale values, and the step of determining whether the color block edge exists between the current pixel, the first adjacent pixel and the second adjacent pixel comprises:
calculating brightness values of the current pixel, the first adjacent pixel and the second adjacent pixel by using the pixel data related to the current pixel, the first adjacent pixel and the second adjacent pixel;
comparing the brightness value of the current pixel with the brightness value of the first adjacent pixel to obtain a first comparison result;
determining whether the color block edge exists between the current pixel and the first adjacent pixel according to the first comparison result;
comparing the brightness value of the current pixel with the brightness value of the second adjacent pixel to obtain a second comparison result; and
determining whether the color block edge exists between the current pixel and the second adjacent pixel according to the second comparison result.

4. The image compensation method according to claim 3, wherein the first comparison result comprises a difference value between the brightness value of the current pixel and the brightness value of the first adjacent pixel, and the step of determining whether the color block edge exists between the current pixel and the first adjacent pixel according to the first comparison result comprises:
determining that the color block edge exists between the current pixel and the first adjacent pixel when the difference value is greater than a threshold value; and
determining that no color block edge exists between the current pixel and the first adjacent pixel when the difference value is less than the threshold value.

5. The image compensation method according to claim 1, wherein the first color fringe compensation comprises:
calculating a weighted average of a brightness value of a target subpixel in the current pixel and a brightness value of a corresponding subpixel in the first adjacent pixel, so as to obtain a new brightness value of the target subpixel in the current pixel.

6. The image compensation method according to claim 5, wherein the target subpixel is one among a plurality of subpixels in the current pixel which is adjacent to the first adjacent pixel.

7. The image compensation method according to claim 1, further comprising:
obtaining, by the image processing circuit, pixel data related to the current pixel and a third adjacent pixel from the image frame when the current pixel is located at a frame edge of the image frame, wherein the frame edge and the third adjacent pixel are respectively located at two opposite sides of the current pixel;
determining, by the image processing circuit, whether the color block edge exists between the current pixel and the third adjacent pixel according to the pixel data related to the current pixel and the third adjacent pixel; and
performing, by the image processing circuit, second color fringe compensation on the pixel data related to the current pixel when determining that no color block edge exists between the current pixel and the third adjacent pixel and a brightness value of the current pixel is greater than a brightness threshold value.

8. The image compensation method according to claim 7, wherein the second color fringe compensation comprises:
multiplying the brightness value of a target subpixel in the current pixel by an adjustment parameter, so as to obtain a new brightness value of the target subpixel in the current pixel.

9. The image compensation method according to claim 8, wherein the adjustment parameter is a positive real number less than 1.

10. The image compensation method according to claim 7, further comprising:
performing, by the image processing circuit, third color fringe compensation on the pixel data related to the current pixel when determining that the color block edge exists between the current pixel and the third adjacent pixel and the brightness value of the current pixel is less than the brightness threshold value.

11. The image compensation method according to claim 10, wherein the third color fringe compensation comprises:
calculating a weighted average of a brightness value of a target subpixel in the current pixel and a brightness value of a corresponding subpixel of the third adjacent pixel, so as to obtain a new brightness value of the target subpixel in the current pixel.

12. An image processing circuit, comprising:
a capture circuit, configured to obtain pixel data related to a current pixel, a first adjacent pixel and a second adjacent pixel from an image frame, wherein the first adjacent pixel and the second adjacent pixel are respectively located at two opposite sides of the current pixel;
an edge determination circuit, coupled to the capture circuit, and configured to determine whether a color block edge exists between the current pixel, the first adjacent pixel and the second adjacent pixel according to the pixel data related to the current pixel, the first adjacent pixel and the second adjacent pixel; and
a compensation circuit, coupled to the edge determination circuit and performing first color fringe compensation on the pixel data related to the current pixel when determining that the color block edge exists between the current pixel and the first adjacent pixel and no color block edge exists between the current pixel and the second adjacent pixel.

13. The image processing circuit according to claim 12, wherein
the compensation circuit does not perform the first color fringe compensation on the pixel data related to the current pixel when determining that no color block edge exists between the current pixel and the first adjacent pixel and no color block edge exists between the current pixel and the second adjacent pixel, and
the compensation circuit does not perform the first color fringe compensation on the pixel data related to the current pixel when determining that the color block edge exists between the current pixel and the first adjacent pixel and the color block edge exists between the current pixel and the second adjacent pixel.

14. The image processing circuit according to claim 12, wherein
the pixel data related to the current pixel, the first adjacent pixel and the second adjacent pixel are grayscale values,
the edge determination circuit calculates brightness values of the current pixel, the first adjacent pixel and the second adjacent pixel by using the pixel data related to the current pixel, the first adjacent pixel and the second adjacent pixel,
the edge determination circuit compares the brightness value of the current pixel with the brightness value of the first adjacent pixel to obtain a first comparison result,
the edge determination circuit determines whether the color block edge exists between the current pixel and the first adjacent pixel according to the first comparison result,
the edge determination circuit compares the brightness value of the current pixel with the brightness value of the second adjacent pixel to obtain a second comparison result, and
the edge determination circuit determines whether the color block edge exists between the current pixel and the second adjacent pixel according to the second comparison result.

15. The image processing circuit according to claim 14, wherein
the first comparison result comprises a difference value between the brightness value of the current pixel and the brightness value of the first adjacent pixel,
the edge determination circuit determines that the color block edge exists between the current pixel and the first adjacent pixel when the difference value is greater than a threshold value, and
the edge determination circuit determines that no color block edge exists between the current pixel and the first adjacent pixel when the difference value is less than the threshold value.

16. The image processing circuit according to claim 12, wherein the first color fringe compensation comprises:
calculating, by the compensation circuit, a weighted average of a brightness value of a target subpixel in the current pixel and a brightness value of a corresponding subpixel in the first adjacent pixel, so as to obtain a new brightness value of the target subpixel in the current pixel.

17. The image processing circuit according to claim 16, wherein the target subpixel is one among a plurality of subpixels in the current pixel which is adjacent to the first adjacent pixel.

18. The image processing circuit according to claim 12, wherein
the capture circuit obtains pixel data related to the current pixel and a third adjacent pixel from the image frame when the current pixel is located at a frame edge of the image frame, wherein the frame edge and the third adjacent pixel are respectively located at two opposite sides of the current pixel,
the edge determination circuit determines whether the color block edge exists between the current pixel and the third adjacent pixel according to the pixel data related to the current pixel and the third adjacent pixel, and
the compensation circuit performs second color fringe compensation on the pixel data related to the current pixel when determining that no color block edge exists between the current pixel and the third adjacent pixel and a brightness value of the current pixel is greater than a brightness threshold value.

19. The image processing circuit according to claim 18, wherein the second color fringe compensation comprises:
multiplying, by the compensation circuit, a brightness value of a target subpixel in the current pixel by an adjustment parameter, so as to obtain a new brightness value of the target subpixel in the current pixel.

20. The image processing circuit according to claim 19, wherein the adjustment parameter is a positive real number less than 1.

21. The image processing circuit according to claim 18, wherein the compensation circuit performs third color fringe compensation on the pixel data related to the current pixel when determining that the color block edge exists between the current pixel and the third adjacent pixel and the brightness value of the current pixel is less than the brightness threshold value.

22. The image processing circuit according to claim 21, wherein the third color fringe compensation comprises:
calculating, by the compensation circuit, a weighted average of a brightness value of a target subpixel in the current pixel and a brightness value of a corresponding subpixel in the third adjacent pixel, so as to obtain a new brightness value of the target subpixel in the current pixel.
